(19) United States
(12) Patent Application Publication
(10) Pub. No.: US 2009/0327877 A1
(43) Pub. Date: Dec. 31, 2009

(54) SYSTEM AND METHOD FOR DISAMBIGUATING TEXT LABELING CONTENT OBJECTS

(75) Inventors: Malcolm Slaney, Santa Clara, CA (US); Kilian Quirin Weinberger, Mountain View, CA (US); Roelof van Zwol, Badalona (ES)

Correspondence Address: Law Office of Robert Bolan, P.O. Box 36, Bellevue, WA, 98009, US

(73) Assignee: Yahoo! Inc., Sunnyvale, CA (US)

(21) Appl. No.: 12/164,039

(22) Filed: Jun. 28, 2008

(51) Int. Cl. G06F 17/27

(52) U.S. Cl. 715/256

(57) ABSTRACT

An improved system and method for disambiguating text strings labeling content objects is provided. A text string set may be received from a user. Frequencies of co-occurring text strings in a text collection may be obtained, and a disambiguation measure may be determined for a pair of text strings that each co-occur with a text string in the text string set. The disambiguation measure may be based on a weighted KL divergence of text string distributions that maximizes the value of divergence when a text string set may occur in different contexts. A disambiguation measure may be determined for a list of the top most common pairs of text strings that co-occur with the text string set, and the pairs of text strings may be output in decreasing order by disambiguation measure for those pairs of text strings with a disambiguation measure that exceeds a threshold.

### FIELD OF THE INVENTION

The invention relates generally to computer systems, and more particularly to an improved system and method for disambiguating text labeling content objects.

### BACKGROUND OF THE INVENTION

The collaborative efforts of users participating in social media services such as Wikipedia, Flickr, and Delicious have led to an explosion in user-generated content. The content can occur in various forms, such as text, photos, video, audio, or multimedia content. A popular way of organizing the content is through tagging. Tags are often contributed by users when they submit an image or video and then form a key part of a search approach. The tags provide useful descriptors of the content and are an important part of today's multimedia databases. A simple tag like “Tokyo” may provide more information than can possibly be gleaned from content-based algorithms. Therefore making it as easy as possible for users to enter tags is important.

There have been numerous efforts to suggest tags to users. See, for example, M. Ames and M. Naaman, Why We Tag: Motivations for Annotation in Mobile and Online Media, Proceedings of the SIGCHI Conference on Human Factors in Computing Systems, pages 971-980, 2007; G. Mishne, AutoTag: A Collaborative Approach to Automated Tag Assignment for Weblog Posts, Proceedings of the 15th International Conference on World Wide Web, pages 953-954, 2006; B. Sigurbjorsnsson and R. van Zwol, Flickr Tag Recommendation Based on Collective Knowledge, In Proceedings of the 17th International World Wide Web Conference (WWW2008), Beijing, China, April 2008; and Z. Xu, Y. Fu, J. Mao, and D. Su, Towards the Semantic Web: Collaborative Tag Suggestions, Collaborative Web Tagging Workshop at WWW2006, Edinburgh, Scotland, May, 2006. A common method is to suggest the most likely co-occuring tags. For instance, Ames and Naaman propose a system called ZoneTag to make it easier for mobile-phone users to tag the photos they upload based on location and previous tags. Both Mishne and Xu propose systems that make suggestions by aggregating tags from similar textual content. And Sigurbjornsson proposes a system based on a probabilistic model of tag usage across all users. Each of these systems is looking for the most likely tags to describe content. However, in many cases, the most likely tag is also the most obvious and least informative. As a result, most tag-suggestion systems suggest words that add little information to a user's contribution.

Instead, disambiguating tags should be recommended when the current tags are not sufficiently clear to describe an object. There are two scenarios when tags are not sufficiently clear to describe an object. The first scenario is if the current tag set has more than one meaning. Resolving this type of ambiguity is non-trivial, as there exist many different ways a tag set can appear ambiguous. Examples of ambiguity are word-sense ambiguity (e.g. “jaguar” can be a car or an animal), geographic ambiguity (e.g. “Cambridge” as in MA or UK), temporal ambiguity (e.g. “Superbowl” from 2006 or 2005), language ambiguity (e.g. “mist” means dung in German and fog in English), and so forth. The second scenario is if the current tag set is not sufficiently specific. For example, “Asia” could describe an image from many different countries, or the tag set (“jaguar,” “car”) is not ambiguous; however, the tag set is also not particularly specific about the type of car that is represented in an image, given there are many Jaguar models.

What is needed is a way to determine the ambiguity of a set of user-contributed tags and suggests new tags that disambiguate the original tags. Ideally, such a system and method should be able to flexibly handle many cases of ambiguity, including word-sense ambiguity, geographic ambiguity, temporal ambiguity, and language ambiguity, without resorting to additional side information such as time or location analysis.

### SUMMARY OF THE INVENTION

The present invention provides a system and method for disambiguating text strings labeling content objects. A disambiguation engine may be provided to disambiguate a text string set by calculating a divergence measure of two augmented text string sets. The disambiguation engine may be operably coupled to an ambiguity analyzer to determine the ambiguity of the text string set and may be operably coupled to a text recommendation engine to recommend a disambiguating text string set. The system and method may suggest new text strings when a set of given text strings can appear in at least two different contexts. These different contexts could be defined by geographic locations, word senses, languages, temporal events, and so forth. The different text string contexts may be measured based on a weighted KL divergence of co-occurring text string distributions. When the measure exceeds a threshold, the system and method suggest text strings that allow users to better describe their content.

In an embodiment to disambiguate text strings labeling content objects, one or more text strings forming a text string set may be received from a user. Alternatively, one or more machine-generated text strings may be provided by a content recognition system. Frequencies of co-occurring text strings in a text collection may be obtained, and a disambiguation measure may be determined for a pair of text strings that each co-occur with a text string in the text string set. In an embodiment, the disambiguation measure may be based on a weighted KL divergence of text string distributions that maximizes the value of divergence when a text string set may occur in different contexts. The pair of text strings may be output as recommendations to a user if the disambiguation measure exceeds a threshold. In various embodiments, a disambiguation measure may be determined for a list of the top most common pairs of text strings that co-occur with the text string set, and the pairs of text strings may be output in decreasing order by disambiguation measure for those pairs of text strings with a disambiguation measure that exceeds a threshold.

There are many applications which may use the present invention for disambiguating text strings labeling content objects. For instance, the present invention may be used to disambiguate tags in online content publishing and social media applications. The present invention may suggest tags that allow users to better describe their content for both new and existing content objects. Additionally, the present invention may be used in search applications to find an expanded query that best resolves ambiguity of a user's search request. Advantageously, the system and method of the present invention may be generally applied to any types of annotated content including, but not limited to, text, images, static graphics, video, audio, and rich media. Other advantages will become apparent from the following detailed description when taken in conjunction with the drawings, in which:

### BRIEF DESCRIPTION OF THE DRAWINGS

FIG. 1 is a block diagram generally representing a computer system into which the present invention may be incorporated;

FIG. 2 is a block diagram generally representing an exemplary architecture of system components for disambiguating text strings labeling content objects, in accordance with an aspect of the present invention;

FIG. 3 is a flowchart generally representing the steps undertaken in one embodiment for disambiguating tags labeling content objects, in accordance with an aspect of the present invention;

FIG. 4 is a flowchart generally representing the steps undertaken in one embodiment for disambiguating tags labeling content objects by a disambiguation engine, in accordance with an aspect of the present invention; and

FIG. 5 is a flowchart generally representing the steps undertaken in one embodiment presents a flowchart generally representing the steps undertaken in one embodiment for disambiguating text of a query, in accordance with an aspect of the present invention.

### DETAILED DESCRIPTION

### Exemplary Operating Environment

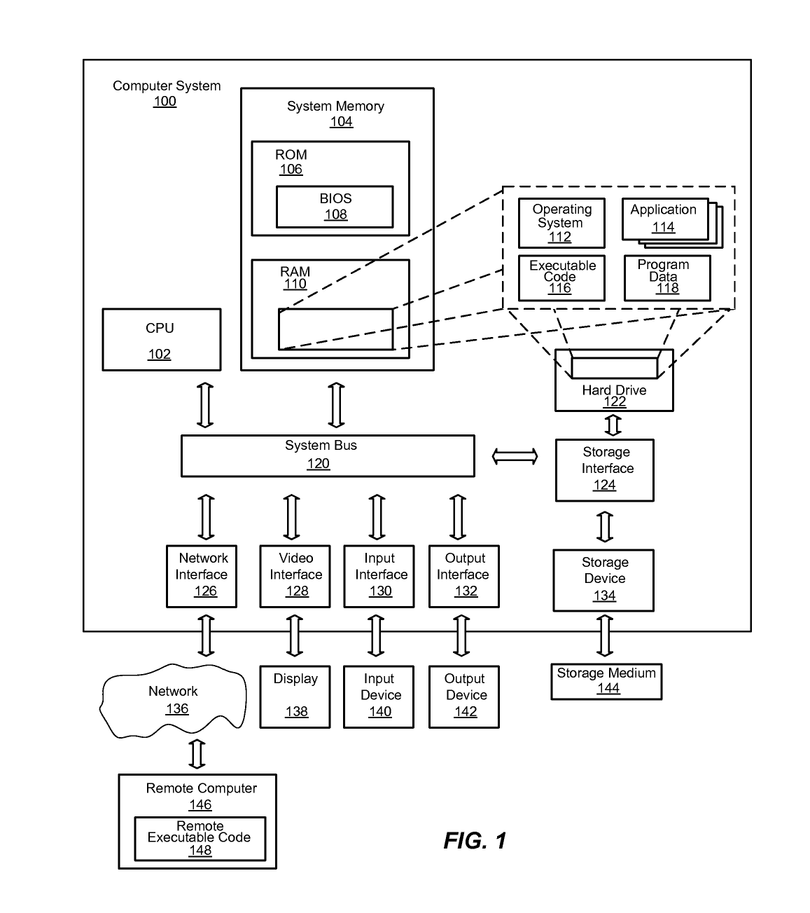

FIG. 1 illustrates suitable components in an exemplary embodiment of a general purpose computing system. The exemplary embodiment is only one example of suitable components and is not intended to suggest any limitation as to the scope of use or functionality of the invention. Neither should the configuration of components be interpreted as having any dependency or requirement relating to any one or combination of components illustrated in the exemplary embodiment of a computer system. The invention may be operational with numerous other general purpose or special purpose computing system environments or configurations.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention may include a general purpose computer system 100. Components of the computer system 100 may include, but are not limited to, a CPU or central processing unit 102, a system memory 104, and a system bus 120 that couples various system components including the system memory 104 to the processing unit 102. The system bus 120 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer system 100 may include a variety of computer-readable media. Computer-readable media can be any available media that can be accessed by the computer system 100 and includes both volatile and nonvolatile media. For example, computer-readable media may include volatile and nonvolatile computer storage media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer system 100. Communication media may include computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. For instance, communication media includes wired media such as a wired network or direct-wired connection, and wireless media such as acoustic, RF, infrared and other wireless media.

The system memory 104 includes computer storage media in the form of volatile and/or nonvolatile memory such as read only memory (ROM) 106 and random access memory (RAM) 110. A basic input/output system 108 (BIOS), containing the basic routines that help to transfer information between elements within computer system 100, such as during start-up, is typically stored in ROM 106. Additionally, RAM 110 may contain operating system 112, application programs 114, other executable code 116 and program data 118. RAM 110 typically contains data and/or program modules that are immediately accessible to and/or presently being operated on by CPU 102.

The computer system 100 may also include other removable/non-removable, volatile/nonvolatile computer storage media. By way of example only, FIG. 1 illustrates a hard disk drive 122 that reads from or writes to non-removable, nonvolatile magnetic media, and storage device 134 that may be an optical disk drive or a magnetic disk drive that reads from or writes to a removable, a nonvolatile storage medium 144 such as an optical disk or magnetic disk. Other removable/non-removable, volatile/nonvolatile computer storage media that can be used in the exemplary computer system 100 include, but are not limited to, magnetic tape cassettes, flash memory cards, digital versatile disks, digital video tape, solid state RAM, solid state ROM, and the like. The hard disk drive 122 and the storage device 134 may be typically connected to the system bus 120 through an interface such as storage interface 124.

The drives and their associated computer storage media, discussed above and illustrated in FIG. 1, provide storage of computer-readable instructions, executable code, data structures, program modules and other data for the computer system 100. In FIG. 1, for example, hard disk drive 122 is illustrated as storing operating system 112, application programs 114, other executable code 116 and program data 118. A user may enter commands and information into the computer system 100 through an input device 140 such as a keyboard and pointing device, commonly referred to as mouse, trackball or touch pad tablet, electronic digitizer, or a microphone. Other input devices may include a joystick, game pad, satellite dish, scanner, and so forth. These and other input devices are often connected to CPU 102 through an input interface 130 that is coupled to the system bus, but may be connected by other interface and bus structures, such as a parallel port, game port or a universal serial bus (USB). A display 138 or other type of video device may also be connected to the system bus 120 via an interface, such as a video interface 128. In addition, an output device 142, such as speakers or a printer, may be connected to the system bus 120 through an output interface 132 or the like computers.

The computer system 100 may operate in a networked environment using a network 136 to one or more remote computers, such as a remote computer 146. The remote computer 146 may be a personal computer, a server, a router, a network PC, a peer device or other common network node, and typically includes many or all of the elements described above relative to the computer system 100. The network 136 depicted in FIG. 1 may include a local area network (LAN), a wide area network (WAN), or other type of network. Such networking environments are commonplace in offices, enterprise-wide computer networks, intranets and the Internet. In a networked environment, executable code and application programs may be stored in the remote computer. By way of example, and not limitation, FIG. 1 illustrates remote executable code 148 as residing on remote computer 146. It will be appreciated that the network connections shown are exemplary and other means of establishing a communications link between the computers may be used.

### Disambiguating Text Labeling Content Objects

The present invention is generally directed towards a system and method for disambiguating text labeling content objects. The system and method may suggest text strings when a set of text strings can appear in at least two different contexts. These different contexts could be defined by geographic locations, word senses, languages, temporal events, and so forth. The different text string contexts may be measured based on a weighted KL divergence of co-occurring text string distributions. When the benefits are significant, the system and method suggest text strings that allow users to better describe their content. In an embodiment, a text string may label any type of content object, including for example bookmarks, photos, videos, video fragments, text, audio, other multimedia content, web pages and even user queries.

As will be seen, the present invention may be used to disambiguate tags in online content publishing and social media applications. The present invention may suggest tags that allow users to better describe their content for both new and existing content objects. Additionally, the present invention may be used in search applications to find an expanded query that best resolves ambiguity of search results. As will be understood, the various block diagrams, flow charts and scenarios described herein are only examples, and there are many other scenarios to which the present invention will apply.

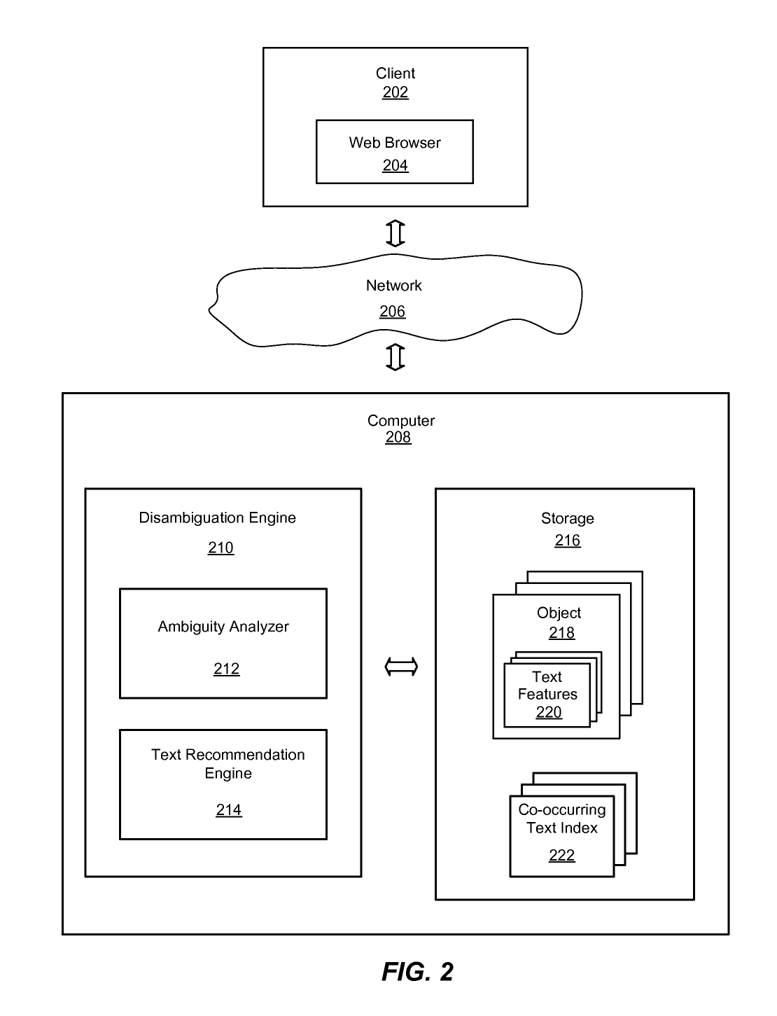

Turning to FIG. 2 of the drawings, there is shown a block diagram generally representing an exemplary architecture of system components for disambiguating text strings labeling content objects. Those skilled in the art will appreciate that the functionality implemented within the blocks illustrated in the diagram may be implemented as separate components or the functionality of several or all of the blocks may be implemented within a single component. For example, the functionality of the ambiguity analyzer 212 may be implemented as a separate component from the text recommendation engine 214 within the disambiguation engine 210 as shown. Or the functionality of the ambiguity analyzer 212 and the text recommendation engine 214 may be implemented in a single component. Moreover, those skilled in the art will appreciate that the functionality implemented within the blocks illustrated in the diagram may be executed on a single computer or distributed across a plurality of computers for execution.

In various embodiments, a client computer 202 may be operably coupled to one or more server computers 208 by a network 206. The client computer 202 may be a computer such as computer system 100 of FIG. 1. The network 206 may be any type of network such as a local area network (LAN), a wide area network (WAN), or other type of network. A web browser 204 may execute on the client computer 202 and may include functionality for receiving text strings labeling a content object from a user and may include functionality for displaying text strings recommended to the user to label the content object. The web browser 204 may be operably coupled to a disambiguation engine 210 that may execute on a server 208. In general, the web browser 204 may be any type of interpreted or executable software code such as a kernel component, an application program, a script, a linked library, an object with methods, and so forth.

The server 208 may be any type of computer system or computing device such as computer system 100 of FIG. 1. In an embodiment, the server 208 may provide services for receiving, accessing and storing text strings and content objects labeled by the text strings. The server 208 may include a disambiguation engine 210 that disambiguates a text string set by calculating a divergence measure of two augmented text string sets. The disambiguation engine 210 may include an ambiguity analyzer 212 for analyzing the ambiguity of text strings. The disambiguation engine 210 may also include a text recommendation engine 214 for recommending disambiguating text strings to label a content object. Each of these modules may also be any type of executable software code such as a kernel component, an application program, a linked library, an object with methods, or other type of executable software code.

The server 212 may be operably coupled to storage such as storage 216 that may store content objects 218 that may include text features 220. The storage 216 may also store text co-occurrence data such as an index 222 mapping the frequency of a text string to other text strings.

There are many applications which may use the present invention for disambiguating text strings labeling content objects. Online content publishing and social media applications are examples among these many applications. For any of these applications, new tags may be generated as needed or daily for both new and existing content items, and these additional tags may be incorporated into a collection of tags labeling content items. For instance, an online photographic sharing application may allow users to upload and share photographs, and may also allow users to annotate the photographs with tags. Those skilled in the art may recognize that other online applications such as news article feeds, blogs or bulletin boards, and multimedia data applications such as images, songs, or movie clips may similarly have tags generated on top of the content. Such applications may use the present invention for disambiguating tags labeling content objects. Or the present invention may be used in search applications to find an expanded query that best resolves ambiguity of a search request.

In general, a text string set may be considered ambiguous if it can appear in at least two different contexts. These different contexts could be defined by geographic locations, word senses, languages, temporal events, and so forth. The text string contexts may be measured by the distribution over all text string co-occurrences. A good example of an ambiguous tag labeling an image, for instance, is the word “Cambridge,” since there are well-known examples of Cambridge in both Massachusetts and England. Suggesting a tag such as “university” is very likely in both contexts, but does little to resolve the ambiguity. The present invention may measure the level of ambiguity of a text string set T and selects two additional text strings that can be proposed to a user to best disambiguate it. Thus, given the tag “Cambridge,” the present invention may determine that this is an ambiguous tag, and suggest either “MA” or “UK” because these words may do the most to remove the ambiguity. It may be assumed that the tag set {“Cambridge” ,“MA.”} co-occurs with different tags than {“Cambridge” ,“UK”}. These additional tags are defined by locations and events that differ strongly between the two very distant cities. As used herein, co-occurring text strings mean two or more text strings that are features describing the same content object.

A probabilistic framework may be introduced that provides a probability p(t|T) that a tag t co-occurs with the set T. Instead of suggesting the tags that are most likely within this framework, two tags tᵢ,tⱼ are suggested that, once added to T, give rise to maximally different probability distributions p(t|{T∪tᵢ}) and p(t|{T∪tⱼ}). The level of ambiguity of a set T is measured by a weighted Kullback-Leibler (KL) divergence of these two probability distributions.

In the proposed probabilistic framework to model tag co-occurrences and measure ambiguity, consider a content object to be labeled with a set of tags T={tₐt_{b}, . . . }. The expression I(T) represents the number of content objects that contain the tag set T. For any pair of tags tᵢ,tⱼ, consider the number of content object co-occurrences to be denoted by I(tᵢ∪tⱼ). An estimate of the probability that one tag, tᵢ, appears in another tag's presence, tⱼ, may be calculated by the following expression:

$$p ( {t}_{i} \vert {t}_{j} ) = \frac{I ( {t}_{i} ⋂ {t}_{j} )}{{\sum }_{k} I ( {t}_{k} ⋂ {t}_{j} )} .$$

By further summing over all contexts, the probability of a pair of tags that includes tag tᵢ may be calculated by the following expression:

$$p ( {t}_{i} ) = \frac{{\sum }_{j} I ( {t}_{i} ⋂ {t}_{j} )}{{\sum }_{j , k} I ( {t}_{k} ⋂ {t}_{j} )} .$$

In an embodiment of a probabilistic framework, models may be based on these two probability distributions, which may be calculated from pair-wise co-occurrence data. Although tags may not appear only in pairs, it is impractical to store the probability of a tag in any context for all tag sets, T. To simplify the computation, it may be assumed that conditional co-occurrences are independent, and the probability that any one tag for all tag sets is used to label a content object may be calculated by the following expression:

$$p ( T \vert {t}_{i} ) = {\prod }_{t ∈ T} p ( t \vert {t}_{i} ) .$$

Using this assumption, the probability of a tag given any context may be written using Bayes' rule as

$$p ( {t}_{i} \vert T ) = \frac{p ( T \vert {t}_{i} ) p ( {t}_{i} )}{p ( T )} = \frac{p ( {t}_{i} ) {\prod }_{t ∈ T} p ( t \vert {t}_{i} )}{{\sum }_{j} p ( {t}_{j} ) {\prod }_{t ∈ T} p ( t \vert {t}_{j} )} .$$

It is important to note that a tag set may be considered ambiguous if it can appear in at least two different tag contexts. Accordingly, a set of labels T may be considered ambiguous if there exist two labels tᵢ and tⱼ such that adding one or the other gives rise to very different distributions over the remaining labels. Thus, given the tag “Cambridge,” adding the tags “MA” or “UK” may lead to very different locations; and the other tags occurring in this context are likely to change, including tags about stores, people, and so forth. In an embodiment, the deviation between two posterior distributions of the different tag contexts may be measured with the KL-divergence. For additional details on measuring two posterior distributions with the KL-divergence, see S. Kullback and R. Leibler, On Information and Sufficiency, in The Annals of Mathematical Statistics, 22 (1):79-86, March 1951. Consider T to denote the current set of tags, and consider tᵢ,tⱼ to be two additional tags. The KL-divergence between the two corresponding distributions may be determined by calculating the following equation:

$$KL ( {t}_{i} ‖ {t}_{j} ) = {\sum }_{t} p ( t \vert T ⋃ \{ {t}_{i} \} ) log ( \frac{p ( t \vert T ⋃ \{ {t}_{i} \} )}{p ( t \vert T ⋃ \{ {t}_{j} \} )} ) .$$

This equation integrates the amount of disagreement between the two distributions over all tags t, weighted by the probability p(t|{T∪tᵢ}). It is strictly non-negative but not necessarily symmetric. Given that there may be no meaningful notion of order for the tags tᵢ,tⱼ, the following commonly used symmetric variation of the equation may instead be used:

K̅L(tᵢ,tⱼ)=KL(tᵢ∥tⱼ)+KL(tⱼ∥tᵢ).

Given a limited data base, it may be possible to easily find tags with maximal disagreement by selecting two terms that appear in very different contexts and are unrelated to the set T. For example, for the tag set T={“Cambridge”}, the tags added could be t₁=“fridge” and t₂=“mercedes” and the KL-divergence between the two posterior distributions would presumably be very high. To avoid this, the equation K̅L(tᵢ,tⱼ)=KL(tᵢ∥tⱼ)+KL(tⱼ∥tᵢ) may be weighted by the conditional probabilities of the two terms, and therefore discount additional tags that have no direct relation with the original tag set. The weighted divergence may be defined as div(tᵢ, tⱼ)=p(tᵢT)p(tⱼT)g( K̅L(tᵢ∥tⱼ)) where g( ) may be a monotonically increasing function that trades off the impact of the KL divergence with the conditional probabilities. In an embodiment, the function g(x) can be any monotonic function that influences the impact of the KL divergence on the output. For example, the function g(x) may be g(x)=x^{e} for a range of values of e between 0 and 6 in various embodiments. In an embodiment for a collection of tags annotating images, there was a peak for an exponent between 2 and 4 in experiments.

Accordingly, the measure of ambiguity of a tag set T may be defined in various embodiments as the maximum divergence between two potential posterior distributions: f(T)=max_{i,j}div(tᵢ,tⱼ). If the value of f(T) is above a certain threshold, the labels tᵢ and tⱼ may be recommended because they represent the “direction” of greatest ambiguity, f(T), to the system.

A naïve implementation of f(T)=max_{i,j}div(tᵢ,tⱼ) generally results in a computational complexity of O(n³), where n denotes the number of terms in the database. However, for any given tag set T, almost all tags tᵢ have a very small conditional probability p(tᵢ|T). In order to find two terms with maximum disambiguation value, it is generally sufficient to restrict the search over the top N most common terms, where N is some small number. From experimentation, N=25 was found to be sufficient in an embodiment, under which 97.5% of all computations resulted in exact results. Even finding the top N tags can be safely approximated, as the majority of all tags are never likely in any context.

For a very large scale implementation in an embodiment, f(T)=max_{i,j}div(tᵢ,tⱼ) may be parallelizable, for instance, in a map-reduce framework described in J. Dean and S. Ghemawat, Map: Simplified Data Processing on Large Clusters, Communications of the ACMC, 51(1):107, 2008. The reduce phase in Dean and Ghemawat may calculate the max( ) operator and the mapper may implement the div( ) operator defined in

div(tᵢ, tⱼ)=p(tᵢ|T)p(tⱼ|T)g( K̅L(tᵢ∥tⱼ)).

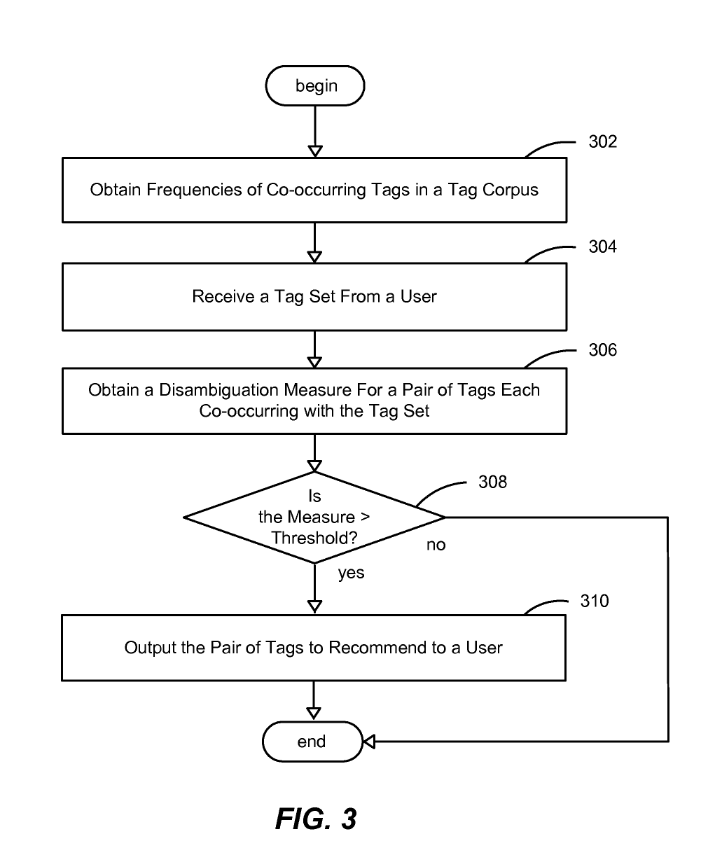

FIG. 3 presents a flowchart generally representing the steps undertaken in one embodiment for disambiguating tags labeling content objects. At step 302, frequencies of co-occurring tags in a collection of tags may be obtained. At step 304, a tag set may be received from a user. As used herein, a tag set means one or more tags. Alternatively, a machine-generated tag set may be provided by a content recognition system. At step 306, a disambiguation measure may be obtained for a pair of tags that each co-occur with a tag in the tag set. In an embodiment, the disambiguation measure for a pair of tags may be calculated as the maximum divergence between two posterior distributions for the probability that the tag set augmented by each one of the pair of tags co-occurs with each tag in a collection of tags, such as f(T)=max_{i,j}div(tᵢ,tⱼ). At step 308, it may be determined whether the measure is greater than a threshold. In an embodiment, the threshold may be set to values from 0 to 10 and may be tuned to increase or decrease the frequency recommendations may be made to a user. If the measure is not greater than a threshold, then processing may be finished. If so, then the pair of tags may be output to recommend to a user at step 310 and processing may be finished.

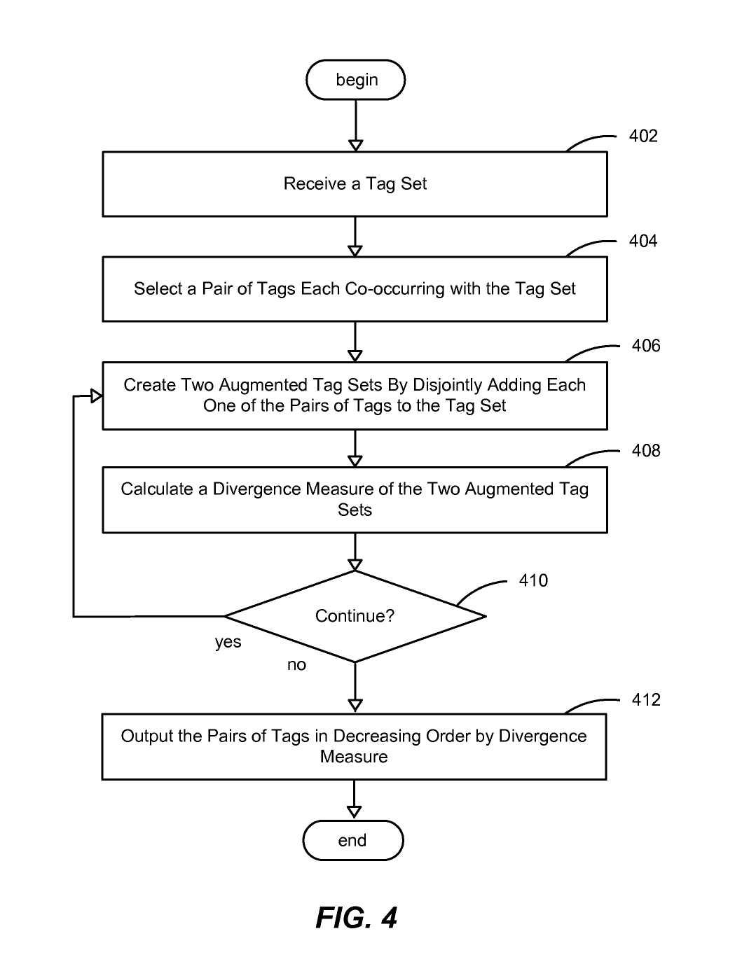

FIG. 4 presents a flowchart generally representing the steps undertaken in one embodiment for disambiguating tags labeling content objects by a disambiguation engine. At step 402, a tag set may be received. For example, the tag set T={“Cambridge”} may be received by a disambiguation engine. At step 404, a pair of tags, each co-occurring with the tag set, may be selected. For the tag set T={“Cambridge”}, the tags t₁=“MA” and t₂=“UK” could be added for instance. At step 406, two augmented tag sets may be created by disjointly adding each one of the pairs of tags to the tag set. Thus, disjointly adding t₁=“MA” and t₂=“UK” to the tag set T={“Cambridge”} results in the two augmented tags sets, {“Cambridge”,“MA”} and {“Cambridge”,“UK” }. At step 408, a divergence measure of the two augmented tag sets may be calculated. In an embodiment, the divergence measure may be calculated by f(T)=max_{i,j}div(tᵢ,tⱼ). At step 410, it may be determined whether to continue to create augmented tag sets. In an embodiment, the process may continue until the top N most common tags have been used to create two augmented tag sets, where N may be some small number such as 25. In another embodiment, the process may continue until there may not be any additional augmented tag sets to be created. At step 412, the pairs of tags may be output in decreasing order by divergence measure.

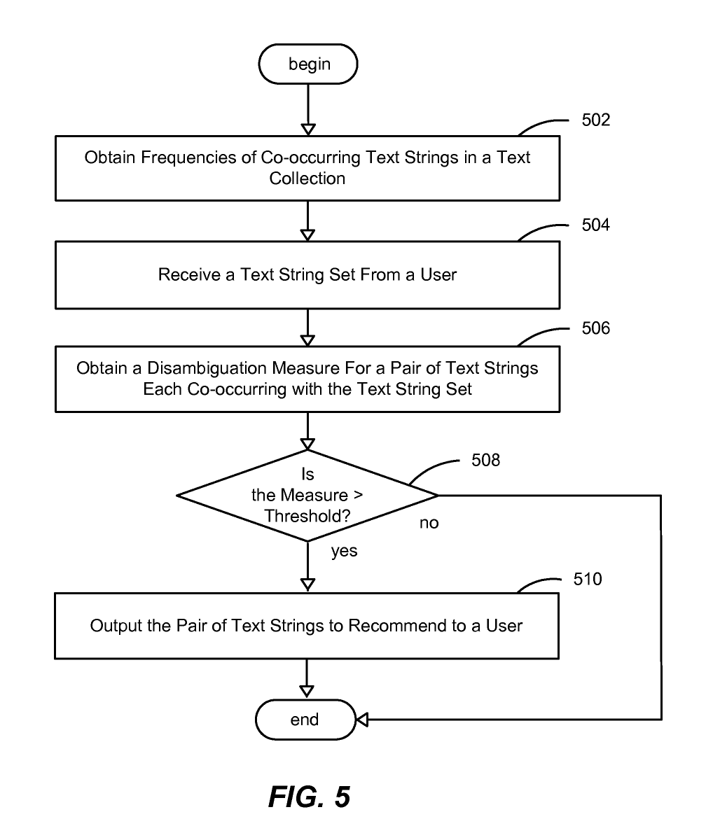

FIG. 5 presents a flowchart generally representing the steps undertaken in one embodiment for disambiguating text of a query. For example, an expanded query may be recommended that best resolves ambiguity of a search query. At step 502, frequencies of co-occurring text strings in a text collection may be obtained. For instance co-occurring terms stored in an index from history of queries may be accessed to obtain frequencies of co-occurring text strings. At step 504, a text string set may be received from a user. A text string set, as used herein, means one or more strings of text. For instance, the text string set may be terms of a query. At step 506, a disambiguation measure may be obtained for a pair of text strings that each co-occur with a text string in the text string set. In an embodiment, the disambiguation measure may be a divergence measure calculated by f(T)=max_{i,j}div(tᵢ,tⱼ). At step 508, it may be determined whether the measure is greater than a threshold. If not, then processing may be finished. If so, then the pair of text strings may be output to recommend to a user at step 510 and processing may be finished. A user may choose one of the pair of text strings as a search query that describes features of web pages returned in the search results.

The present invention provides a system and method to suggest text strings when a set of text strings can appear in at least two different contexts. These different contexts could be defined by geographic locations, word senses, languages, temporal events, and so forth. The text string contexts may be measured by the distribution over all text string co-occurrences using a measure of ambiguity based on a weighted KL divergence of text string distributions. Advantageously, a text string is suggested that allow people to better describe their content when the benefits are significant.

As can be seen from the foregoing detailed description, the present invention provides an improved system and method for disambiguating text strings labeling content objects. A disambiguation measure based on a weighted KL divergence of tag distributions may be determined that maximizes the value of divergence when a tag set may occur in different contexts. When the benefits are significant, the system and method suggest text strings that allow users to better describe their content. Advantageously, the system and method of the present invention may be generally applied to any types of annotated content including, but not limited to, text, images, static graphics, video, audio, and rich media. As a result, the system and method provide significant advantages and benefits needed in contemporary computing, and more particularly in online applications supporting user-defined content.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A computer system for disambiguating text, comprising:
a disambiguation engine to disambiguate a text string set by calculating a divergence measure of two augmented text string sets; and
a storage operably coupled to the disambiguation engine for storing a plurality of objects represented by a plurality of text features.

2. The system of claim 1 further comprising an ambiguity analyzer operably coupled to the disambiguation engine to analyze the ambiguity of the text string set.

3. The system of claim 1 further comprising a text recommendation engine operably coupled to the disambiguation engine to recommend disambiguating text for the text string set.

4. The system of claim 1 wherein the storage further comprises a co-occurring text index mapping a frequency of a text string to a plurality of other text strings.

5. A computer-readable medium having computer-executable components comprising the system of claim 1.

6. A computer-implemented method for disambiguating text, comprising:
receiving a text string set;
creating two augmented text string sets by disjointly adding each of a pair of text strings to the text string set;
obtaining a disambiguation measure for the two augmented text string sets; and
outputting the pair of text strings if the disambiguation measure exceeds a threshold.

7. The method of claim 6 further comprising obtaining frequencies of co-occurring text strings in a collection of text strings.

8. The method of claim 7 further comprising selecting the pair of text strings co-occurring with the text string set.

9. The method of claim 8 wherein selecting the pair of text strings co-occurring with the text string set comprises searching an index of co-occurring text strings to find the pair of text strings in the collection of text strings that co-occur with greatest frequency.

10. The method of claim 6 wherein outputting the pair of text strings comprises recommending the pair of text strings to a user.

11. The method of claim 6 wherein creating two augmented text string sets by disjointly adding each of the pair of text strings to the text string set comprises determining two probability distributions, each probability distribution representing a probability that each of the pair of text strings co-occurs with the text string set.

12. The method of claim 6 wherein obtaining a disambiguation measure for the two augmented text string sets comprises measuring a weighted Kullback-Leibler divergence of two probability distributions, each probability distribution representing one of the two augmented text string sets.

13. The method of claim 6 wherein receiving the text string set comprises receiving geographical metadata labeling a content object.

14. The method of claim 6 wherein receiving the text string set comprises receiving temporal metadata labeling a content object.

15. The method of claim 6 wherein receiving the text string set comprises receiving a tag set labeling a content object.

16. The method of claim 6 wherein receiving the text string set comprises receiving a search query.

17. A computer-readable medium having computer-executable instructions for performing the method of claim 6.

18. A computer system for disambiguating text, comprising:
means for receiving at least one text string;
means for finding a pair of text strings to disambiguate the at least one text string; and
means for recommending the pair of text strings to a user to disambiguate the at least one text string.

19. The computer system of claim 18 further comprising:
means for creating two augmented text string sets by disjointly adding each of a pair of text strings to the at least one text string; and
means for obtaining a disambiguation measure for the two augmented text string sets.

20. The computer system of claim 18 wherein means for recommending the pair of text strings to the user to disambiguate the at least one text string comprises means for determining whether a disambiguation measure exceeds a threshold.
